(19) United States
(12) Patent Application Publication
(10) Pub. No.: US 2011/0240157 A1
(43) Pub. Date: Oct. 6, 2011

(54) PIPELINE PROTECTION SYSTEMS

(76) Inventors: David John Jones, Gloucestershire (GB); Richard Barry Sims, Gloucestershire (GB)

(21) Appl. No.: 13/139,057

(22) PCT Filed: Dec. 3, 2009
(86) PCT No.: PCT/GB2009/051646

§ 371 Date: Jun. 10, 2011

(30) Foreign Application Priority Data
Dec. 11, 2008 (GB) 0822597.1

(51) Int. Cl. F17D 5/00

(52) U.S. Cl. 137/613

(57) ABSTRACT

A valve arrangement for a pipeline protection system comprises a plurality of barrier valves in series with each other for coupling in a pipeline, wherein the valves are received in a metallic block.

### CROSS-REFERENCE TO RELATED APPLICATIONS

This is a national stage application under 35 U.S.C. §371(c) of prior-filed, co-pending PCT patent application serial number PCT/GB2009/051646, filed on Dec. 3, 2009, which claims priority to British patent application serial number 0822597.1, filed on Dec. 11, 2008, each of which is hereby incorporated by reference in its entirety.

### BACKGROUND OF THE INVENTION

1. Field of the Invention

This invention relates to pipeline protection systems for detecting and reducing overpressure in a fluid pipeline.

2. Description of the Prior Art

Hydrocarbon wells, for example subsea oil wells, require a pipeline through which the hydrocarbon fluid is transported. In the case of subsea wells, these may be of substantial length, sometimes several tens of kilometres long. Consequently, the pipeline is a major cost element of the fluid extraction system. Many subsea wells have to contend with very high fluid pressures, for example as high as 700 bar. For a pipeline to withstand such pressure would require it to have a substantial wall thickness, and it is not cost-effective to implement this for long pipelines. To decrease cost, it is preferable instead to reduce the maximum operating pressure of the pipeline, typically to about 200 bar, using devices such as valves or chokes to reduce the fluid pressure from the well. However, a failure of the pressure reducing device may result in overpressure in the pipeline with disastrous results. To prevent this happening, a pipeline protection system is typically incorporated into the pipeline proximate the well. Such a system must have high integrity and virtually guarantee to prevent any overpressure from the well from reaching the pipeline.

A known form of pipeline protection system is disclosed in UK Patent No. 2 401 164.

Also, FIG. 1 shows a typical conventional high integrity pipeline protection system (HIPPS). Two hydraulically operated ‘HIPPS’ barrier valves 1 and 2 are inserted in a fluid extraction flow line 3, prior to a thinner walled pipeline 4. These valves are opened when their operating hydraulic cylinders are fed with hydraulic pressure, and closed, typically under spring pressure, when the hydraulic pressure is removed and vented, i.e. they are failsafe. Pressure transducers 5, 6 and 7 are fitted between the valves 1 and 2. The pressure transducers 5, 6 and 7 are connected to a subsea control module (SCM) 8, which houses a hard-wired (and thus also high integrity), electronic safety critical control board. This board produces an output that energises directional control valves (DCVs) which in turn operate the valves 1 and 2. The DCVs are also failsafe in that they close the hydraulic pressure source, and open the valve 1 and 2 actuating cylinders to vent when de-energised. Thus, loss of electrical or hydraulic power causes the valves 1 and 2 to close. The safety critical control board in the SCM 8 contains logic that de-energises the DCVs if two out of the three transducers 5, 6 and 7 indicate a pressure level that exceeds a pre-set limit. This limit is set to a pressure that is less than the safe operating pressure of the pipeline 4. The use of two fail-safe HIPPS valves, three pressure transducers and failsafe DCVs ensures high integrity of the system.

Although such a known HIPPS is effective at protecting the pipeline, it is relatively basic, and does not address the problem of reducing the overpressure in the fluid system, which should be reduced before the HIPPS valves are re-opened and normal operation resumed. It is of course preferable that the overpressure is reduced in a controlled manner which minimizes the risk of component damage.

GB-A-2 439 552 discloses a HIPPS for detecting and reducing overpressure in a fluid pipeline having a fluid input end and a fluid output end, the fluid input end being connected in use to a fluid source. First and second pipeline valves are connected in series along the pipeline with the first pipeline valve being connected at a location closer to the input end than the connection location of the second pipeline valve, the first and second pipeline valves being independently switchable between open positions in which fluid flow through the pipeline is permitted and closed positions in which fluid flow through the pipeline is blocked. Pressure sensors determine the fluid pressure in the pipeline at a point intermediate the first and second pipeline valves; a bypass line has a first end connected to the pipeline between the input end and the first pipeline valve and a second end connected to the pipeline between the first and second pipeline valves; a bypass valve is connected along the bypass line, the bypass valve being switchable between an open position in which fluid flow through the bypass line is permitted and a closed position in which fluid flow through the bypass line is blocked; a vent line is connected to the bypass line between the bypass valve and the second end of the bypass line, the vent line leading to venting means; and a vent valve is connected along the vent line, the vent valve being switchable between an open position in which fluid flow through the vent line is permitted and a closed position in which fluid flow through the vent line is blocked.

To provide a HIPPS module for a subsea hydrocarbon extraction well, an SCM, input and output flow line connectors, the HIPPS barrier valves and the pressure sensors can be carried by the framework, which can be lowered towards the seabed. However, such a module can have undesirably large dimensions and an undesirably large weight.

### SUMMARY OF THE INVENTION

According to the present invention, there is provided a valve arrangement for a pipeline protection system, comprising a plurality of barrier valves in series with each other for coupling in a pipeline, wherein the valves are received in a metallic block.

The metallic block could also receive at least one bypass valve for the system,

The metallic block could also receive at least one vent valve for the system.

The metallic block could carry at least one sensor for sensing pressure in the pipeline in use of the arrangement.

The present invention also comprises a pipeline protection system comprising a valve arrangement according to the invention and a control module therefor.

The present invention will now be described, by way of example, with reference to the accompanying drawing, in which:

### BRIEF DESCRIPTION OF THE DRAWINGS

FIG. 1 shows a known form of HIPPS; and

FIG. 2 is a schematic diagram of one example of a valve arrangement according to the invention.

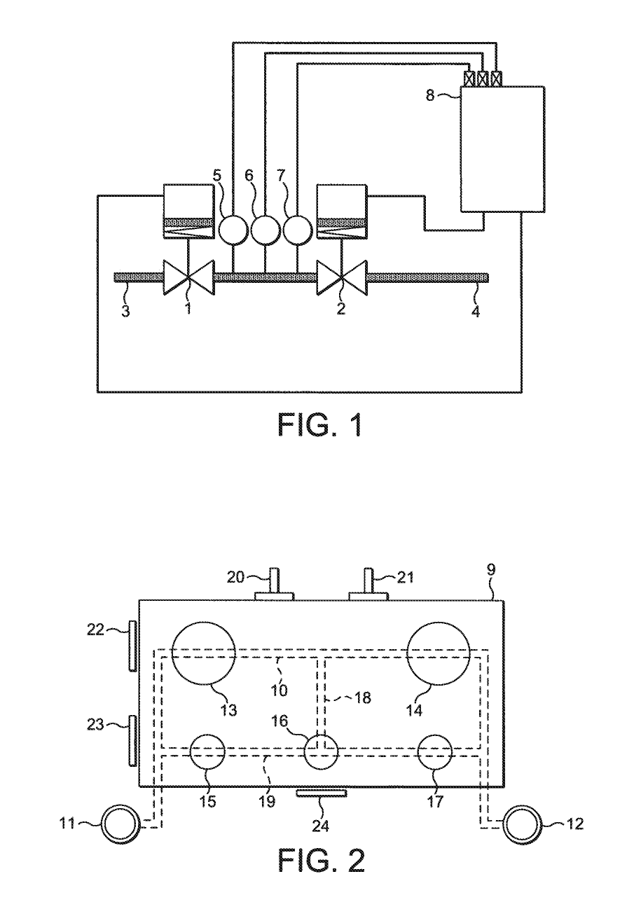

### DETAILED DESCRIPTION OF THE INVENTION

Referring to FIG. 2, reference numeral 9 denotes a metallic block in the form of a one-piece machined forging of, for example, chrome-molybdenum steel formed internally with a bore 10 which communicates with an input connector 11 and an output connector 12 so that the arrangement can be coupled in a hydrocarbon fluid pipeline of a subsea well. Reference numerals 13 and 14 denote two HIPPS barrier valves in series with each other and so that they are coupled in the pipeline via bore 10.

Inside the block 10 there also two bypass valves (not shown) and, in the particular example, three vent valves 15, 16 and 17, connected in the arrangement via machined bores 18 and 19 in the block 9. In operation, a vent line from the vent valves vents into a low pressure flow line.

Reference numerals 20 and 21 denote pressure sensors mounted on the block and connected, in use of the arrangement, to an SCM. Although only two are shown, in practice four are preferably used, the arrangement being such that an over-pressure is assumed to exist if at least two of the sensors indicate the same.

To prevent corrosion and erosion of the bores 10, 18 and 19, they are coated internally with, for example, “Inconel” (RTM), such as “Inconel 625”.

Finally, reference numerals 22, 23 and 24 denote cover flanges provided to seal off openings which exist as a result of machining of the bores.

Advantages enabled by the present invention are: installation to a manifold can be provided via vertical access and recovery by pulling up of the arrangement; limited connection loads on the framework of a HIPPS module; reduced weight and height; and fewer possible leakage paths.

1-5. (canceled)

6. A valve arrangement for a pipeline protection system, the valve arrangement comprising a plurality of barrier valves in series with each other for coupling in a pipeline, wherein the valves are received in a metallic block.

7. The arrangement of claim 6, wherein at least one bypass valve for the system is also received in the metallic block.

8. The arrangement of claim 6, wherein at least one vent valve for the system is also received in the metallic block.

9. The arrangement of claim 6, wherein the metallic block carries at least one sensor for sensing pressure in the pipeline in use of the arrangement.

10. The arrangement of claim 7, wherein at least one vent valve for the system is received in the metallic block.

11. The arrangement of claim 7, wherein the metallic block carries at least one sensor for sensing pressure in the pipeline in use of the arrangement.

12. A valve arrangement for a pipeline protection system, the valve arrangement comprising a plurality of barrier valves in series with each other for coupling in a pipeline, wherein the valves are received in a metallic block, at least one bypass valve for the system is also received in the metallic block, at least one vent valve for the system is also received in the metallic block and the metallic block carries at least one sensor for sensing pressure in the pipeline in use of the arrangement.

13. A pipeline protection system comprising a valve arrangement and a control module therefor, the valve arrangement comprising a plurality of barrier valves in series with each other for coupling in a pipeline, wherein the valves are received in a metallic block.

14. The system of claim 13, wherein at least one bypass valve for the system is also received in the metallic block.

15. The system of claim 13, wherein at least one vent valve for the system is also received in the metallic block.

16. The system of claim 13, wherein the metallic block carries at least one sensor for sensing pressure in the pipeline in use of the system.

17. The system of claim 14, wherein at least one vent valve for the system is also received in the metallic block.

18. The system of claim 14, wherein the metallic block carries at least one sensor for sensing pressure in the pipeline in use of the arrangement.

19. The system of claim 13, wherein at least one bypass valve for the system is also received in the metallic block, at least one vent valve for the system is also received in the metallic block and the metallic block carries at least one sensor for sensing pressure in the pipeline in use of the system.
